(19) United States
(12) Patent Application Publication
(10) Pub. No.: US 2026/0163654 A1
(43) Pub. Date: Jun. 11, 2026

(54) SIGNALING ASPECTS OF MISALIGNMENT ESTIMATION AND COMPENSATION FOR LINE OF SIGHT MULTIPLE INPUT MULTIPLE OUTPUT COMMUNICATIONS

(71) Applicant: QUALCOMM INCORPORATED, San Diego, CA (US)

(72) Inventors: Pinar Sen, San Diego, CA (US); Abdelrahman Mohamed Ahmed Mohamed Ibrahim, San Diego, CA (US); Seyong Park, San Diego, CA (US); Renqiu Wang, San Diego, CA (US); Muhammad Sayed Khairy Abdelghaffar, San Jose, CA (US); Yu Zhang, San Diego, CA (US); Krishna Kiran Mukkavilli, San Diego, CA (US); Tingfang Ji, San Diego, CA (US)

(21) Appl. No.: 18/707,041

(22) PCT Filed: Dec. 10, 2021
(86) PCT No.: PCT/CN2021/137022

§ 371 Date: May 2, 2024

(51) Int. Cl. H04B 17/12; H04B 7/06

(52) U.S. Cl. CPC H04B 17/12; H04B 7/0691

(57) ABSTRACT

Methods, systems, and devices for signaling aspects of misalignment estimation and compensation for line of sight (LOS) multiple input multiple output (MIMO) communications are described. In some examples, a user equipment (UE) may receive control signaling identifying a configuration for an alignment procedure for an antenna array of the UE that includes a plurality of antenna elements. In some examples, the UE may identify a misalignment factor for the antenna array according to the identified configuration. The UE may communicate with the network entity using the antenna array based at least in part on performing a compensation procedure for the antenna array of the UE based at least in part on the misalignment factor.

### CROSS REFERENCE

The present application is a 371 national stage filing of International PCT Application No. PCT/CN2021/137022 by Sen et al. entitled “SIGNALING ASPECTS OF MISALIGNMENT ESTIMATION AND COMPENSATION FOR LINE OF SIGHT MULTIPLE INPUT MULTIPLE OUTPUT COMMUNICATIONS,” filed Dec. 10, 2021, which is assigned to the assignee hereof, and which is expressly incorporated by reference in its entirety herein.

### FIELD OF TECHNOLOGY

The following relates to wireless communications, including signaling aspects of misalignment estimation and compensation for line of sight (LOS) multiple input multiple output (MIMO) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may experience communication inefficiencies such as antenna array misalignments. For example, a transmitting antenna array and a receiving antenna array may be misaligned, reducing communication throughput.

### SUMMARY

The described techniques relate to improved methods, systems, devices, and apparatuses that support signaling aspects of misalignment estimation and compensation for line of sight multiple input multiple output communications. Generally, the described techniques provide for an antenna to adjust one or more antennas at a user equipment (UE), a base station, or both. For example, the alignment procedure may be configured in radio resource control (RRC) signaling, where the base station may trigger re-alignment by media access control (MAC) control element (CE) signaling. In some examples, the base station may configure an alignment measurement through RRC signaling. In some examples, the base station may configure or trigger a realignment procedure using RRC signaling. For example, the base station may transmit realignment control to the UE triggering an antenna panel realignment procedure, for example, the misalignment procedure as described with reference to the base station transmitting the alignment control.

A method for wireless communication at a user equipment (UE) is described. The method may include receiving control signaling identifying a configuration for an alignment procedure for an antenna array of the UE that includes a set of multiple antenna elements, identifying a misalignment factor for the antenna array according to the identified configuration, and communicating with the network entity using the antenna array based on performing a compensation procedure for the antenna array of the UE based on the misalignment factor.

An apparatus for wireless communication at a UE is described. The apparatus may include a processor, memory coupled with the processor, and instructions stored in the memory. The instructions may be executable by the processor to cause the apparatus to receive control signaling identifying a configuration for an alignment procedure for an antenna array of the UE that includes a set of multiple antenna elements, identify a misalignment factor for the antenna array according to the identified configuration, and communicate with the network entity using the antenna array based on performing a compensation procedure for the antenna array of the UE based on the misalignment factor.

Another apparatus for wireless communication at a UE is described. The apparatus may include means for receiving control signaling identifying a configuration for an alignment procedure for an antenna array of the UE that includes a set of multiple antenna elements, means for identifying a misalignment factor for the antenna array according to the identified configuration, and means for communicating with the network entity using the antenna array based on performing a compensation procedure for the antenna array of the UE based on the misalignment factor.

A non-transitory computer-readable medium storing code for wireless communication at a UE is described. The code may include instructions executable by a processor to receive control signaling identifying a configuration for an alignment procedure for an antenna array of the UE that includes a set of multiple antenna elements, identify a misalignment factor for the antenna array according to the identified configuration, and communicate with the network entity using the antenna array based on performing a compensation procedure for the antenna array of the UE based on the misalignment factor.

Some examples of the method, apparatuses, and non-transitory computer-readable medium described herein may further include operations, features, means, or instructions for transmitting, to the network entity, an indication of a capability of the UE to perform the alignment procedure for the antenna array of the UE, where the configuration for the alignment procedure may be received at least in part in response to the capability.

Some examples of the method, apparatuses, and non-transitory computer-readable medium described herein may further include operations, features, means, or instructions for receiving, from the network entity, a control message indicating for the UE to perform the alignment procedure, where the UE determines the misalignment factor at least in part in response to receiving the control message.

In some examples of the method, apparatuses, and non-transitory computer-readable medium described herein, the received control message identifies one or more parameters that the UE may be to use for the alignment procedure.

In some examples of the method, apparatuses, and non-transitory computer-readable medium described herein, identifying the misalignment factor may include operations, features, means, or instructions for receiving a reference signal from the network entity according to the configuration for the alignment procedure and determining the misalignment factor for the antenna array based on the received reference signal from the network entity.

Some examples of the method, apparatuses, and non-transitory computer-readable medium described herein may further include operations, features, means, or instructions for transmitting a second reference signal according to the configuration for the network entity, the transmitted second reference signal for the network entity to perform the alignment procedure on a second antenna array of the network entity.

In some examples of the method, apparatuses, and non-transitory computer-readable medium described herein, the received reference signal includes a channel state information reference signal (CSI-RS).

In some examples of the method, apparatuses, and non-transitory computer-readable medium described herein, identifying the misalignment factor may include operations, features, means, or instructions for transmitting a reference signal according to the configuration for the alignment procedure and receiving, from the network entity, the misalignment factor for the antenna array at least in part in response to the transmitted reference signal.

Some examples of the method, apparatuses, and non-transitory computer-readable medium described herein may further include operations, features, means, or instructions for receiving a control message identifying a set of misalignment factors, where receiving the misalignment factor includes receiving an indicator of the misalignment factor from the set of misalignment factors.

Some examples of the method, apparatuses, and non-transitory computer-readable medium described herein may further include operations, features, means, or instructions for receiving the misalignment factor may be associated with an expiry of an alignment timer, or a misalignment value satisfying an alignment threshold, or a combination thereof.

In some examples of the method, apparatuses, and non-transitory computer-readable medium described herein, the indicator of the misalignment factor from the set of misalignment factors may be received in a media access control element or a downlink control information (DCI) message.

In some examples of the method, apparatuses, and non-transitory computer-readable medium described herein, receiving the misalignment factor may include operations, features, means, or instructions for receiving a DCI message identifying the misalignment factor.

In some examples of the method, apparatuses, and non-transitory computer-readable medium described herein, the transmitted reference signal includes a sounding reference signal (SRS).

Some examples of the method, apparatuses, and non-transitory computer-readable medium described herein may further include operations, features, means, or instructions for performing the compensation procedure for the antenna array according to the misalignment factor includes modifying a physical parameter of the antenna array, a pre-processing procedure for signals to be transmitted by the UE, a post-processing procedure for signals received by the UE, or any combination thereof.

In some examples of the method, apparatuses, and non-transitory computer-readable medium described herein, the compensation procedure may be performed at least in part by the UE and may be performed at least in part by the network entity.

A method for wireless communication at a network entity is described. The method may include transmitting, to a UE, control signaling identifying a configuration for an alignment procedure for an antenna array of the network entity that includes a set of multiple antenna elements, identifying a misalignment factor for the antenna array according to the identified configuration, and communicating with the UE using the antenna array based on performing a compensation procedure for the antenna array of the network entity based on the misalignment factor.

An apparatus for wireless communication at a network entity is described. The apparatus may include a processor, memory coupled with the processor, and instructions stored in the memory. The instructions may be executable by the processor to cause the apparatus to transmit, to a UE, control signaling identifying a configuration for an alignment procedure for an antenna array of the network entity that includes a set of multiple antenna elements, identify a misalignment factor for the antenna array according to the identified configuration, and communicate with the UE using the antenna array based on performing a compensation procedure for the antenna array of the network entity based on the misalignment factor.

Another apparatus for wireless communication at a network entity is described. The apparatus may include means for transmitting, to a UE, control signaling identifying a configuration for an alignment procedure for an antenna array of the network entity that includes a set of multiple antenna elements, means for identifying a misalignment factor for the antenna array according to the identified configuration, and means for communicating with the UE using the antenna array based on performing a compensation procedure for the antenna array of the network entity based on the misalignment factor.

A non-transitory computer-readable medium storing code for wireless communication at a network entity is described. The code may include instructions executable by a processor to transmit, to a UE, control signaling identifying a configuration for an alignment procedure for an antenna array of the network entity that includes a set of multiple antenna elements, identify a misalignment factor for the antenna array according to the identified configuration, and communicate with the UE using the antenna array based on performing a compensation procedure for the antenna array of the network entity based on the misalignment factor.

Some examples of the method, apparatuses, and non-transitory computer-readable medium described herein may further include operations, features, means, or instructions for receiving, from the UE, an indication of a capability of the UE to perform the alignment procedure, where the configuration for the alignment procedure may be transmitted at least in part in response to the capability.

Some examples of the method, apparatuses, and non-transitory computer-readable medium described herein may further include operations, features, means, or instructions for transmitting, to the UE, a control message indicating for the UE to perform the alignment procedure.

In some examples of the method, apparatuses, and non-transitory computer-readable medium described herein, identifying the misalignment factor may include operations, features, means, or instructions for transmitting a reference signal to the UE according to the configuration for the alignment procedure and receiving, from the UE, the misalignment factor for the antenna array at least in part in response to the transmitted reference signal.

In some examples of the method, apparatuses, and non-transitory computer-readable medium described herein, receiving the misalignment factor for the antenna array at least in part in response to the transmitted reference signal may include operations, features, means, or instructions for receiving a CSI report including one or more of a channel quality information (CQI) field, precoding matrix indicator, rank indicator, or any combination thereof, that indicate the misalignment factor.

Some examples of the method, apparatuses, and non-transitory computer-readable medium described herein may further include operations, features, means, or instructions for transmitting a control message identifying a set of misalignment factors, where receiving the misalignment factor includes receiving an indicator of the misalignment factor from the set of misalignment factors.

Some examples of the method, apparatuses, and non-transitory computer-readable medium described herein may further include operations, features, means, or instructions for transmitting the misalignment factor may be associated with an expiry of an alignment timer, or a misalignment value satisfying an alignment threshold, or a combination thereof.

In some examples of the method, apparatuses, and non-transitory computer-readable medium described herein, the indicator of the misalignment factor from the set of misalignment factors may be transmitted in a media access control element or a DCI message.

In some examples of the method, apparatuses, and non-transitory computer-readable medium described herein, identifying the misalignment factor may include operations, features, means, or instructions for receiving a reference signal from the UE entity according to the configuration for the alignment procedure and determining the misalignment factor for the antenna array based on the received reference signal from the UE.

### BRIEF DESCRIPTION OF THE DRAWINGS

FIGS. 1 and 2 illustrate examples of wireless communications systems that support signaling aspects of misalignment estimation and compensation for line of sight (LOS) multiple input multiple output (MIMO) communications in accordance with aspects of the present disclosure.

FIG. 3 illustrates an example of a process flow that supports signaling aspects of misalignment estimation and compensation for LOS MIMO communications in accordance with aspects of the present disclosure.

FIGS. 4 and 5 show block diagrams of devices that support signaling aspects of misalignment estimation and compensation for LOS MIMO communications in accordance with aspects of the present disclosure.

FIG. 6 shows a block diagram of a communications manager that supports signaling aspects of misalignment estimation and compensation for LOS MIMO communications in accordance with aspects of the present disclosure.

FIG. 7 shows a diagram of a system including a device that supports signaling aspects of misalignment estimation and compensation for LOS MIMO communications in accordance with aspects of the present disclosure.

FIGS. 8 and 9 show block diagrams of devices that support signaling aspects of misalignment estimation and compensation for LOS MIMO communications in accordance with aspects of the present disclosure.

FIG. 10 shows a block diagram of a communications manager that supports signaling aspects of misalignment estimation and compensation for LOS MIMO communications in accordance with aspects of the present disclosure.

FIG. 11 shows a diagram of a system including a device that supports signaling aspects of misalignment estimation and compensation for LOS MIMO communications in accordance with aspects of the present disclosure.

FIGS. 12 through 17 show flowcharts illustrating methods that support signaling aspects of misalignment estimation and compensation for LOS MIMO communications in accordance with aspects of the present disclosure.

### DETAILED DESCRIPTION

Some wireless communications systems may experience communication inefficiencies such as antenna array misalignments. For example, a transmitting antenna array and a receiving antenna array may be misaligned, reducing communication throughput. There may be several examples of antenna array misalignments that may destroy communication performance. In some examples, a first antenna array and a second antenna array may be rotationally misaligned, where the first antenna array and the second antenna array may be misaligned by an angular offset. In some examples, the first antenna array and the second antenna array may be linearly misaligned, where the first antenna array and the second antenna array may be shifted linearly with respect to one another.

In some examples, an alignment procedure may be configured in radio resource control (RRC) signaling, where a network node may trigger re-alignment by media access control (MAC) control element (CE) signaling. In some examples, a network node may configure an alignment measurement through RRC signaling. For example, a base station may transmit an alignment control to the user equipment (UE) to trigger a misalignment measurement procedure. In some examples, the UE may measure the misalignment using a downlink reference signal. For example, the alignment control may configure the UE to measure a subsequent downlink reference signal, where the base station may transmit the downlink reference signal and the UE may estimate the antenna misalignment by measuring the downlink reference signal. In some examples, the base station may measure the misalignment using an uplink reference signal. For example, the alignment control may configure the UE to transmit an uplink reference signal to the base station, where the base station may estimate the antenna misalignment by measuring the uplink reference signal.

In some examples, a network node may configure or trigger a realignment procedure using RRC signaling. For example, the base station may transmit realignment control to the UE triggering an antenna panel realignment procedure, for example, the misalignment procedure as described with reference to the base station transmitting the alignment control.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to signaling aspects of misalignment estimation and compensation for LOS MIMO communications.

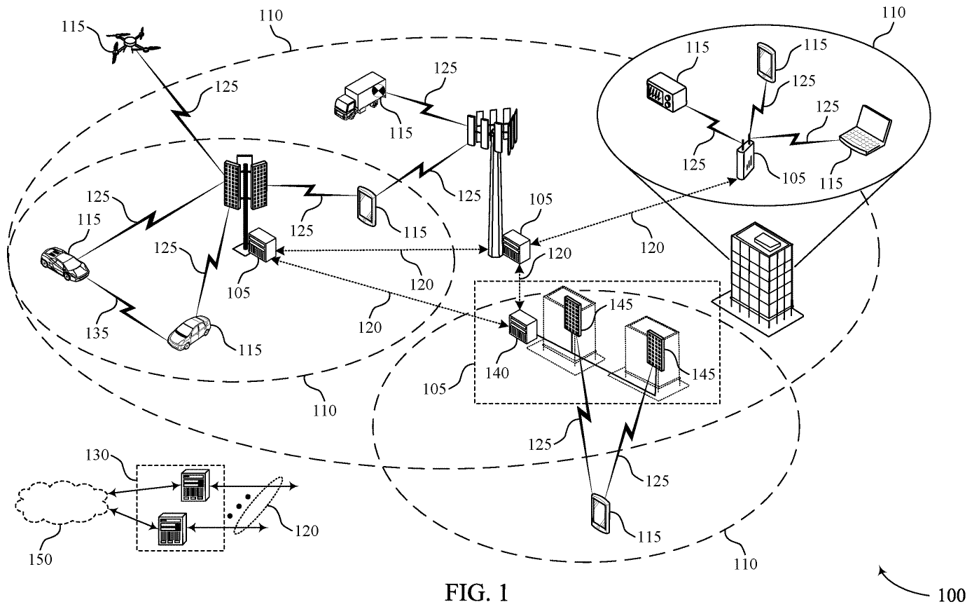

FIG. 1 illustrates an example of a wireless communications system 100 that supports signaling aspects of misalignment estimation and compensation for line of sight (LOS) multiple input multiple output (MIMO) communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IOT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, MIMO communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

There may be several examples of antenna array misalignments that may destroy communication performance. In some examples, a first antenna array and a second antenna array may be rotationally misaligned. In some examples, the first antenna array and the second antenna array may be linearly misaligned.

In some examples, an alignment procedure may be configured in RRC signaling, where a network node may trigger re-alignment by MAC-CE signaling. In some examples, a network node may configure an alignment measurement through RRC signaling. For example, a base station 105 may transmit an alignment control to the UE 115 to trigger a misalignment measurement procedure. In some examples, the UE 115 may measure the misalignment using a downlink reference signal. For example, the alignment control may configure the UE 115 to measure a subsequent downlink reference signal, where the base station 105 may transmit the downlink reference signal and the UE 115 may estimate the antenna misalignment by measuring the downlink reference signal. In some examples, the base station 105 may measure the misalignment using an uplink reference signal. For example, the alignment control may configure the UE 115 to transmit an uplink reference signal to the base station 105, where the base station 105 may estimate the antenna misalignment by measuring the uplink reference signal.

In some examples, a network node may configure or trigger a realignment procedure using RRC signaling. For example, the base station 105 may transmit realignment control to the UE 115 triggering an antenna panel realignment procedure, for example, the misalignment procedure as described with reference to the base station 105 transmitting the alignment control.

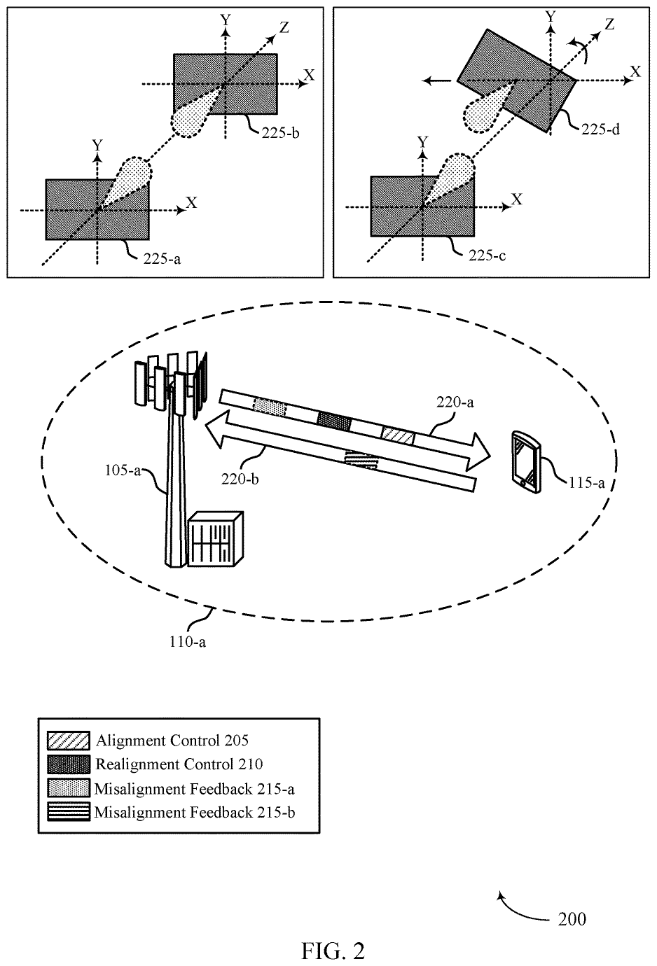

FIG. 2 illustrates an example of a wireless communications system 200 that supports signaling aspects of misalignment estimation and compensation for LOS MIMO communications in accordance with aspects of the present disclosure. The wireless communications system 200 may implement or be implemented by aspects of the wireless communications system 100. For example, wireless communications system 200 may include a base station 105-a and a UE 115-a which may be examples of corresponding devices as described with reference to FIG. 1. In some examples, the UE 115-a and the base station 105-a may exchange signaling supporting antenna realignment at the UE 115-a, the base station 105-a or both.

Some wireless communications systems, such as wireless communications system 200, may support LOS MIMO. In some examples, LOS MIMO may provide high multiplexing gain with the satisfaction of one or more conditions. For example, LOS MIMO may provide high multiplexing gain in cases where a distance between a transmitting antenna and a receiving antenna is less than a distance threshold, where the distance threshold may depend on apertures of the transmitting antenna, the receiving antenna, a carrier frequency, or a combination thereof. Phrased alternatively LOS MIMO may provide high multiplexing gain in cases where the transmitting antenna and the receiving antenna are relatively close (e.g., as compared to a distance threshold based on antenna apertures and a carrier frequency). In some examples, LOS MIMO may provide high multiplexing gain in cases where devices use accurate LOS MIMO precoders. For example, a transmitting device may acquire channel knowledge (e.g., channel conditions, channel quality) and may generate an LOS MIMO precoder based thereon. Additionally or alternatively, communicating devices may feedback distance information to one another and may perform misalignment compensation based thereon, for example, for generating an accurate LOS MIMO precoder.

There are multiple deployment scenarios where wireless communications systems perform LOS MIMO differently. For example, LOS MIMO may be performed in a backhaul link between a network node (e.g., a gNB, an IAB node, a sidelink UE 115) and a relay (e.g., an IAB node, a smart repeater, a customer provided equipment (CPE), drones). In another example, LOS MIMO may be performed in an access link between a network node (or relay) and a UE 115.

In some examples, wireless devices may estimate communications channels (e.g., for LOS spatial multiplexing (LSM), M-MIMO) in accordance with a channel model. For example, wireless devices may estimate communications channels in accordance with a Rician channel model. That is, Equation 1 may be used to estimate communications channels.

$$H = a {H}_{L O S} + b {H}_{N L O S} \qquad ( 1 )$$

In Equation 1, H_{LOS} may represent an LOS channel metric, and may be equal to

$${H}_{L O S} = \frac{exp ( - i 2 π \frac{{r}_{j k}}{λ} )}{\frac{{r}_{j k}}{λ}} ,$$

where rⱼₖ may be a distance between a transmitter antenna and a receiver antenna and A may be a wavelength of a carrier frequency. In some examples, H_{NLOS} may represent an non-LOS (NLOS) channel metric and may be determined by a Raleigh distribution, a clustered delay line (CDL), a tapped delay line (TDL), or a combination thereof. In some examples, a and b are weight factors associated with the channel being composed of an LOS component and an NLOS component, respectively. For example, a²+b²=1, where a² may be a percentage of the channel being composed of LOS communications. In some cases, LSM and M-MIMO may be compared at least in accordance with Equation 1 and referencing Table 1.

TABLE 1

| | LSM | M-MIMO |
|---|---|---|
| Antenna Arrays | Circular, 1D, 2D | 1D, 2D |
| Channel Matrix | Strong LOS Component (a >> b) | Weak LOS Component (a << b) |
| SVD-based Precoder | Implicit, benefitting from the special | Explicit, CSF may be used at the |
| | structure of channel (e.g., limited, no | transmitter side to compute SVD |
| | joint caching and downlink resource | |
| | sharing optimization framework | |
| | (CSF)) | |

In Table 1, the antenna arrays row represents the different types of antenna arrays that may be used for LSM and M-MIMO. Further, the channel matrix row represents the dominating weight factor in Equation 1 that may aid a wireless device in determining whether to use LSM or M-MIMO. For example, in cases where there is a strong LOS component, a wireless device may determine to use LSM. In some cases, LSM and M-MIMO may differ in a singular value decomposition (SVD) precoder, where determining a precoder may be implicit in cases where devices use LSM and explicit in cases where devices use M-MIMO.

In some examples, the structure of an LOS MIMO channel may be exploited to achieve high multiplexing gain. For example, multiplexing gain of an LOS MIMO channel may depend on an antenna separation as well as a distance between a transmitting and receiving array. Further, enhanced performance may be captured in cases where transmitting and receiving arrays are aligned. That is, antenna array misalignment may result in relatively poor signal quality as compared to a signal quality associated with perfectly aligned antennas.

There may be several examples of antenna array misalignments that may destroy communication performance. In the example of wireless communications system 200, the base station 105-a and the UE 115-a may both be equipped with one or more respective antenna arrays 225. For example, the base station 105-a may be equipped with antenna array 225-a or antenna array 225-c and the UE 115-a may be equipped with antenna array 225-b or antenna array 225-d, each of which may lie in an X-Y plane where a Z axis may pass through the center of the antenna array 225-a and antenna array 225-b or antenna array 225-c and antenna array 225-d. In some examples, the antenna array 225-a and the antenna array 225-b may be substantially aligned. That is, antenna array 225-a and antenna array 225-b may produce or otherwise use communication beams that align with the z-axis, resulting in high throughput communications.

Comparatively, antenna array 225-c and antenna array 225-d may be misaligned, where respective communication beams may be askew, resulting in reduced or lower throughput communications. For example, in wireless communications system 200, the antenna array 225-c may be rotated with respect to the Z-axis, or rotated within the X-Y plane relative to the antenna array 225-d. Rotating the antenna array 225-c with respect to the Z-axis may be equivalently referred to as “parallel rotation.” Although, not illustrated in communications system 200, in some examples, the antenna array 225-c may be rotated with respect to the X-axis or the Y-axis relative to the antenna array 225-d. Rotating the antenna array 225-c with respect to the X-axis or the Y-axis relative to the antenna array 225-d may be equivalently referred to as “perpendicular rotation.” In some examples, the antenna array 225-c and the antenna array 225-d may be linearly misaligned. In other words, the centers of antenna array 225-c and the antenna array 225-d may be shifted with respect to one another (e.g., parallel shifting). For example, in wireless communications system 200, the antenna array 225-c may be shifted in the X direction, resulting in a misalignment of the antenna arrays.

Although not illustrated in wireless communications system 200, the antenna array 225-c may be shifted in the Y direction, or both in the X and Y direction (e.g., shift in x-coordinates, y-coordinates, or both) resulting in a misalignment of the antenna array's 225. Even though the antenna arrays 225 are depicted as 2D rectangular antenna arrays 225, the techniques as described herein may be applied to 1D antenna arrays 225, 2D antenna arrays 225, circular antenna arrays 225, among other types of antenna arrays. In some examples, misalignment handling may be important for wireless communications systems using such antenna arrays 225.

In some examples, an alignment procedure may be configured in RRC signaling, where a network node may trigger re-alignment (e.g., of antenna arrays 225) by MAC-CE signaling (e.g., in cases where a UE 115 may support mechanical realignment reported in UE capability signaling). In some examples, one or more devices may be capable of realigning antenna arrays 225. For example, the UE 115-a may be capable of realigning antenna array 225-d physically (e.g., rotation via a motor), or digitally (e.g., signal post-processing), or both. Further, in some cases, the UE 115-a may support the use of LOS RS exchange between the UE 115-a and the base station 105-a, where the UE 115-a and the base station 105-a may use the LOS RS to realign antenna arrays 225. In such examples, the UE 115-a may support alignment reporting, where the UE 115-a may report, to the base station 105-a, the capability of the UE 115-a to realign the antenna array 225-d, the capability of the UE 115-a to support LOS RS exchange, or a combination thereof. Such alignment reporting may be reported periodically, in response to an event (e.g., a trigger from another wireless device, a threshold being satisfied), aperiodically, semi-statically, or any combination thereof.

In some examples, a network node may configure an alignment measurement through RRC signaling. For example, the base station 105-a may transmit alignment control 205 to the UE 115-a to trigger a misalignment measurement procedure. In some examples, the UE 115-a may measure the misalignment using a downlink reference signal. For example, the alignment control 205 may configure the UE 115-a to measure a subsequent downlink reference signal, where the base station 105-a may transmit the downlink reference signal and the UE 115-a may estimate the antenna misalignment by measuring the downlink reference signal. In some cases, the UE 115-a may perform an antenna realignment. For example, in cases where the UE 115-a supports realignment, the UE 115-a may realign the antenna array 225-b in accordance with the misalignment measurement. In some cases, the UE 115-a may feedback the misalignment estimation to a network node and the network node may perform an antenna alignment. That is, upon performing the misalignment measurement, the UE 115-a may transmit misalignment feedback 215-b to the base station 105-a, where the base station 105-a may perform an antenna alignment physically (e.g., rotation via a motor), digitally (e.g., signal post-processing), or both, such that antenna array 225-c aligns with antenna array 225-d. For example, in cases where the base station 105-a supports realignment, the base station 105-a may realign the antenna array 225-a in accordance with the misalignment feedback 215-b. In some examples, the base station 105-a may measure the misalignment from an uplink reference signal (e.g., RRC or MAC CE by the base station 105-a triggers the UE 115-a to send the uplink reference signal). For example, the alignment control 205 may configure the UE 115-a to transmit an uplink reference signal to the base station 105-a, where the base station 105-a may estimate the antenna misalignment from the uplink reference signal. In some cases, the base station 105-a may perform an antenna realignment. For example, in cases where the base station 105-a supports realignment, the base station 105-a may realign the antenna array 225-a in accordance with the misalignment measurement. In some cases, the base station 105-a may feedback the misalignment estimation to the UE 115-a and the UE 115-a may perform an antenna alignment (e.g., in cases where the UE 115-a has mechanical alignment capability). That is, upon performing the misalignment measurement, the base station 105-a may transmit misalignment feedback 215-a to the UE 115-a, where the UE 115-a may align antenna array 225-b in accordance with the misalignment feedback 215-a.

In some examples, a network node may configure or trigger a realignment procedure using RRC signaling. For example, the base station 105-a may transmit realignment control 210 to the UE 115-a triggering an antenna array 225 realignment procedure, for example, the misalignment procedure as described with reference to the base station 105-a transmitting the alignment control 205. In some examples, the realignment control 210 may include parameters such as a flag to control whether the UE 115-a may perform antenna alignment, a parameter specifying an alignment type (e.g., rotation about the x, y, or z-axis), a parameter specifying an alignment amount (e.g., a table with a certain granularity which may be specified with RRC signaling), or a combination thereof. In some examples, if the UE 115-a supports antenna alignment, the base station 105-a may transmit a MAC CE to the UE 115-a, triggering a realignment procedure.

In some examples, the UE 115-a and the base station 105-a may follow one or more procedures when performing a misalignment estimation. In some cases, the UE 115-a may measure the misalignment from downlink reference signals. In such cases, the wireless communications system 200 may define a reference signal for LOS mode for misalignment. For example, the base station 105-a may transmit an LOS reference signal to the UE 115-a to use to measure antenna misalignment. In some examples, the UE 115-a may support a report back mechanism (e.g., when configured by RRC signaling). For example, the base station 105-a may transmit RRC signaling to configure the UE 115-a to report back a misalignment measurement. In some examples, the UE 115-a may transmit the report as a CSI report, in some cases, reusing one or more fields in the CSI report (e.g., bit fields in channel quality indicator (CQI), PMI, or rank indicator (RI) with a certain granularity). In other examples, the UE 115-a may transmit the report as a layer 2 (L2) report. For example, the UE 115-a may transmit an uplink LOS MAC CE, reporting one of multiple entries configured in RRC signaling for misalignment. In such examples, the report may be triggered based on a timer, one or more thresholds (e.g., a parameter exceeding a threshold enough to trigger the MAC CE), among other triggers initiating transmission of the report. In yet other examples, the UE 115-a may transmit the report as a layer 1 (L1) report. For example, the UE 115-a may define an L1 CSI report for misalignment (e.g., up to a certain granularity) with a triggering mechanism (e.g., triggered by MAC CE or downlink control information (DCI)).

In some cases, the base station 105-a may measure the misalignment from uplink reference signals, for example, RRC or MAC CE triggered by a network node (e.g., the base station 105-a). In other words, the base station 105-a may transmit an RRC or a MAC CE message to the UE 115-a, triggering the UE 115-a to transmit an uplink reference signal to the base station 105-a that the base station 105-a may use to estimate antenna array 225 misalignment. In such cases, the wireless communications system 200 may define a reference signal for LOS mode for misalignment. For example, the UE 115-a may transmit an LOS reference signal to the base station 105-a with one or more usage options (e.g., misalignment measurement). In some examples, the base station 105-a may be configured to feedback misalignment information back to the UE 115-a. For example, the base station 105-a may transmit a downlink LOS MAC CE to report one of multiple entries configured at an RRC layer for misalignment (e.g., a k-factor). In such examples, the downlink LOS MAC CE may be triggered based on a timer, one or more thresholds (e.g., a parameter exceeding a threshold enough to trigger the MAC CE), among other triggers initiating transmission of the downlink LOS MAC CE. In some examples, the base station 105-a may transmit a DCI to the UE 115-a (e.g., in a field such as a bitmap or a pointer, pointing to a table of values) to report misalignment. In some examples, the wireless communications system 200 may support misalignment correction using both a downlink reference signal and an uplink reference signal. In such examples, the base station 105-a and the UE 115-a may use specially designed reference signals for LOS from both sides (e.g., in cases where the alignment procedure may be split between the base station 105-a and the UE 115-a).

In some examples, the base station 105-a, the UE 115-a, or both, may be configured to perform a misalignment compensation (e.g., a realignment). For example, a receiving device may be configured to perform a physical calibration (e.g., rotation), a post-processing compensation (e.g., a digital alignment), or both. In another example, a transmitting device may be configured to perform a physical calibration (e.g., rotation), a post-processing compensation (e.g., a digital alignment), or both. In such examples, the UE 115-a and the base station 105-a may perform the actions of transmitting devices or receiving devices depending on whether the UE 115-a and the base station 105-a are transmitting or receiving. In yet other examples, the network node (e.g., the base station 105-a) and the UE 115-a may split the alignment. For example, the base station 105-a and the UE 115-a may individually tune respective antenna arrays 225 with coarse tuning, fine tuning, or both. In another example, such as in cases where both the UE 115-a and the base station 105-a are configured for misalignment estimation and are capable of physical alignment (e.g., rotation with a motor), both the UE 115-a and the base station 105-a may rotate respective antenna arrays 225 for correction. In such examples, the base station 105-a and the UE 115-a each may be configured to rotate such antenna arrays 225, perform a parallel shift antenna arrays 225, or a combination thereof.

Configuring wireless devices to perform antenna array 225 alignment and realignment may result in higher quality communications, enhanced coordination between devices, greater transmission throughput, among other examples.

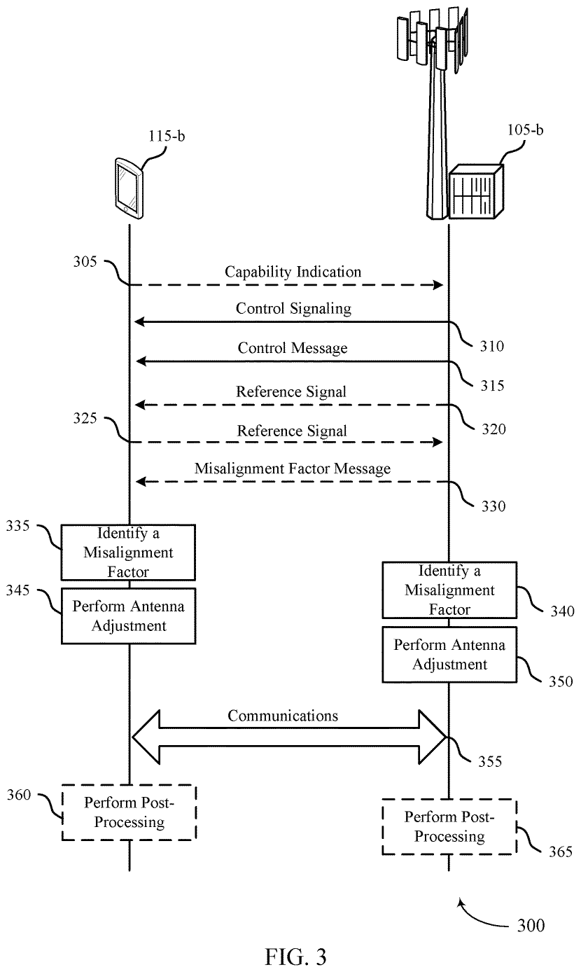

FIG. 3 illustrates an example of a process flow 300 that supports signaling aspects of misalignment estimation and compensation for LOS MIMO communications in accordance with aspects of the present disclosure. In some examples, the process flow: 300 may implement aspects of wireless communications systems 100 or 200. For example, process flow 300 may include UE 115-b and base station 105-b, which may be examples of corresponding devices as described with reference to FIGS. 1 and 2. In some examples, the UE 115-b and the base station 105-b to perform a misalignment procedure to realign one or more antennas at the UE 115-b, the base station 105-b, or both.

In the following description of the process flow 300, the operations may be performed (e.g., reported or provided) in a different order than the order shown, or the operations performed by the UE 115-b and the base station 105-b may be performed in different orders or at different times. For example, specific operations also may be left out of the process flow 300, or other operations may be added to the process flow 300. Further, although some operations or signaling may be shown to occur at different times for discussion purposes, these operations may actually occur at the same time.

In some examples, at 305, the UE 115-b may transmit, and the base station 105-b may receive an indication of a capability of the UE 115-b to perform the alignment procedure for an antenna array of the UE 115-b, where the configuration for the alignment procedure may be received at least in part in response to the capability. For example, the UE 115-b may indicate, to the base station 105-b, a capability of the UE 115-b to physically adjust one or more antennas (e.g., rotation via a motor), digitally adjust received signals, pre-processing signals, among other readjustment capabilities.

At 310, the base station 105-b may transmit, and the UE 115-b may receive control signaling identifying a configuration for an alignment procedure for an antenna array of the UE 115-b that includes a plurality of antenna elements. For example, the control signaling may identify whether the UE 115-b, the base station 105-b, or both may perform one or more subsequent steps in the alignment procedure. The alignment procedure may include one or more aspects as described with reference to FIG. 2, for example, exchanging signaling supporting realignment of one or more antennas at the UE 115-b, the base station 105-b, or both.

At 315, the base station 105-b may transmit, and the UE 115-b may receive a control message indicating for the UE 115-b to perform the alignment procedure, where the UE 115-b may determine a misalignment factor (e.g., an amount of rotational misalignment between an antenna panel of a transmitter and an antenna panel of a receiver relative to a coordinate system due to rotation along one or more of the x, y, and/or z directions, or an amount of relative shift misalignment between an antenna panel of a transmitter and an antenna panel of a receiver relative to a coordinate system in one or more of the x, y, and/or z directions, or both) at least in part in response to receiving the control message. For example, the base station 105-b may transmit RRC signaling to the UE 115-b for the UE 115-b to perform the alignment procedure. In some cases, the base station 105-b may transmit a MAC CE signal to the UE 115-b indicating that the UE 115-b may perform a realignment procedure. In some examples, the control message may identify one or more parameters that the UE 115-b may use for the alignment procedure, for example, identifying an alignment type (e.g., x/y/z-axis rotation), an alignment amount, among other parameters.

In some examples, at 320, the base station 105-b may transmit, and the UE 115-b may receive a reference signal according to the configuration for the alignment procedure. For example, the base station 105-b may transmit a CSI-RS to the UE 115-b according to the configuration. In such cases, the UE 115-b may determine the misalignment factor for the antenna array based at least in part on the received reference signal from the base station 105-b.

Additionally, in some cases, at 325, the UE 115-b may transmit, and the base station may receive a second reference signal according to the configuration for the base station 105-b, the transmitted second reference signal for the base station 105-b to perform the alignment procedure on a second array of the network entity.

In some examples, at 325, the UE 115-b may transmit, and the base station 105-b may receive a reference signal according to the configuration for the alignment procedure, where, at 330, the base station 105-b may feed back to the UE 115-b, a misalignment factor for the antenna array based at least in part in response to the transmitted reference signal at 325. In some examples, at 330, the base station 105-b may transmit, and the UE 115-b may receive a misalignment factor message, where in some cases, the misalignment factor message may be a control message identifying a set of misalignment factors (e.g., a table of misalignment factors, stored misalignment factors), where receiving the misalignment factor includes receiving an indicator of the misalignment factor from the set of misalignment factors. In some cases, receiving the misalignment factor may be associated with an expiry of an alignment factor, or a misalignment value satisfying an alignment threshold, or a combination thereof. In some cases, the indicator of the misalignment factor from the set of misalignment factors may be received in a MAC CE or a DCI message. In some examples, receiving the misalignment factor may include receiving a DCI message identifying the misalignment factor.

As such, at 335, the UE 115-b may identify the misalignment factor and at 340, the base station 105-b may identify the misalignment factor such that the base station 105-b and the UE 115-b may perform misalignment compensation. In some examples, the UE 115-b, at 345 may perform an antenna adjustment, for example, a physical adjustment such as rotation or parallel shifting via a motor, pre-processing a signal to be transmitted to the base station 105-a, among other physical adjustments. In some examples, the base station 105-b, at 350 may perform an antenna adjustment, for example, a physical adjustment such as rotation or parallel shifting via a motor, pre-processing a signal to be transmitted to the UE 115-a, among other physical adjustments.

At 345, the base station 105-b and the UE 115-b may communicate with one another using adjusted antenna parameters, resulting in higher throughput communications. That is, the UE 115-b may communicate with the base station 105-b using the antenna array based at least in part on performing a compensation procedure for the antenna array of the UE 115-b based at least in part on the misalignment factor. In some examples, performing the compensation procedure for the antenna array according to the misalignment factor may include modifying a physical parameter of the antenna array (e.g., rotating the antenna array), a pre-processing procedure (e.g., a transmitting device may perform precoding on a signal based on the amount of misalignment to rotate and direct a beam toward a receiving antenna panel) for signals to be transmitted by the UE 115-b (e.g., digital alignment), a post-processing procedure for signals received by the UE 115-b (e.g., digital alignment), or any combination thereof. In some cases, the compensation procedure may be performed at least in part by the UE 115-b and may be performed at least in part by the base station 105-b.

In some examples, at 360, the UE 115-a may perform post-processing on signaling from the base station 105-a, for example, based on the amount of misalignment to adjust a received signal. In some examples, at 365, the base station 105-a may perform post-processing on signaling from the UE 115-a, for example, based on the amount of misalignment to adjust a received signal.

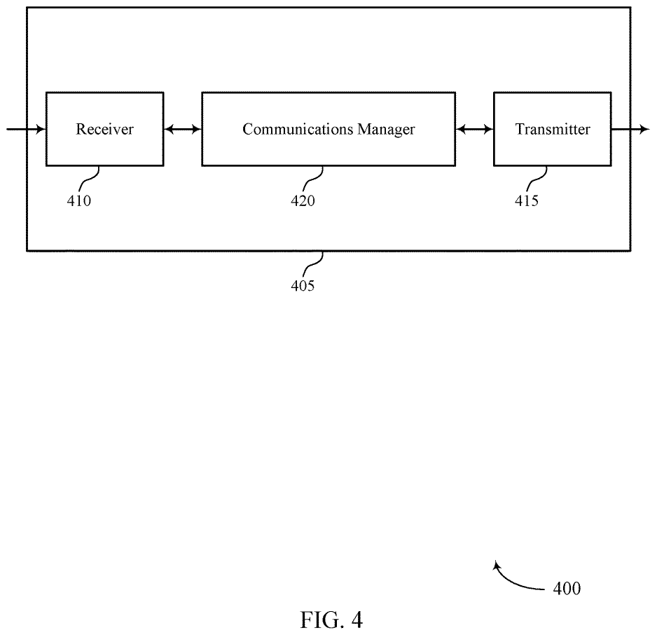

FIG. 4 shows a block diagram 400 of a device 405 that supports signaling aspects of misalignment estimation and compensation for LOS MIMO communications in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to signaling aspects of misalignment estimation and compensation for LOS MIMO communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to signaling aspects of misalignment estimation and compensation for LOS MIMO communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of signaling aspects of misalignment estimation and compensation for LOS MIMO communications as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving control signaling identifying a configuration for an alignment procedure for an antenna array of the UE that includes a set of multiple antenna elements. The communications manager 420 may be configured as or otherwise support a means for identifying a misalignment factor for the antenna array according to the identified configuration. The communications manager 420 may be configured as or otherwise support a means for communicating with the network entity using the antenna array based on performing a compensation procedure for the antenna array of the UE based on the misalignment factor.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for misalignment estimation to adjust antennas at the UE, a base station, or other communicating devices, resulting in reduced processing, reduced power consumption, more efficient utilization of communication resources, and higher throughput communications.

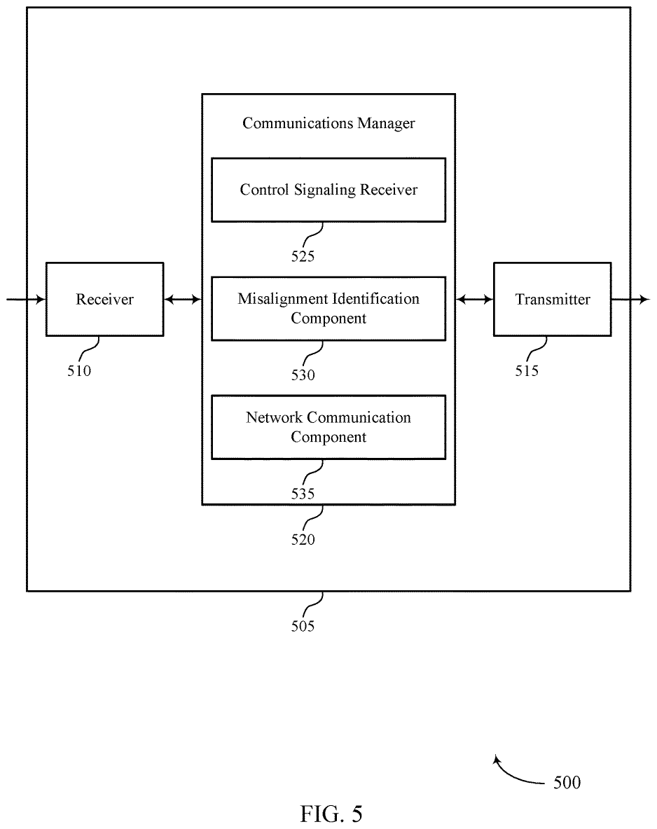

FIG. 5 shows a block diagram 500 of a device 505 that supports signaling aspects of misalignment estimation and compensation for LOS MIMO communications in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to signaling aspects of misalignment estimation and compensation for LOS MIMO communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to signaling aspects of misalignment estimation and compensation for LOS MIMO communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of signaling aspects of misalignment estimation and compensation for LOS MIMO communications as described herein. For example, the communications manager 520 may include a control signaling receiver 525, a misalignment identification component 530, a network communication component 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The control signaling receiver 525 may be configured as or otherwise support a means for receiving control signaling identifying a configuration for an alignment procedure for an antenna array of the UE that includes a set of multiple antenna elements. The misalignment identification component 530 may be configured as or otherwise support a means for identifying a misalignment factor for the antenna array according to the identified configuration. The network communication component 535 may be configured as or otherwise support a means for communicating with the network entity using the antenna array based on performing a compensation procedure for the antenna array of the UE based on the misalignment factor.

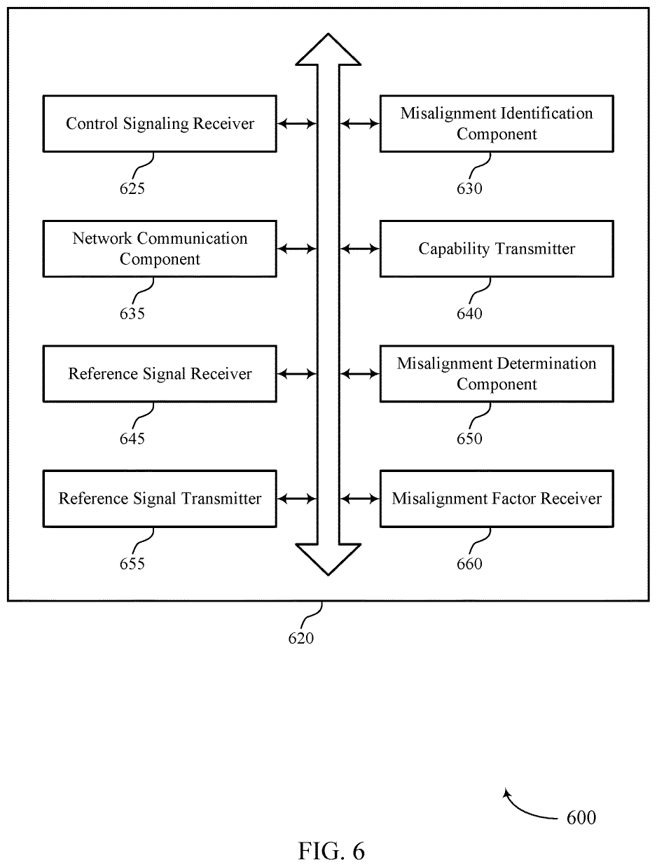

FIG. 6 shows a block diagram 600 of a communications manager 620 that supports signaling aspects of misalignment estimation and compensation for LOS MIMO communications in accordance with aspects of the present disclosure. The communications manager 620 may be an example of aspects of a communications manager 420, a communications manager 520, or both, as described herein. The communications manager 620, or various components thereof, may be an example of means for performing various aspects of signaling aspects of misalignment estimation and compensation for LOS MIMO communications as described herein. For example, the communications manager 620 may include a control signaling receiver 625, a misalignment identification component 630, a network communication component 635, a capability transmitter 640, a reference signal receiver 645, a misalignment determination component 650, a reference signal transmitter 655, a misalignment factor receiver 660, or any combination thereof. Each of these components may communicate, directly or indirectly, with one another (e.g., via one or more buses).

The communications manager 620 may support wireless communication at a UE in accordance with examples as disclosed herein. The control signaling receiver 625 may be configured as or otherwise support a means for receiving control signaling identifying a configuration for an alignment procedure for an antenna array of the UE that includes a set of multiple antenna elements. The misalignment identification component 630 may be configured as or otherwise support a means for identifying a misalignment factor for the antenna array according to the identified configuration. The network communication component 635 may be configured as or otherwise support a means for communicating with the network entity using the antenna array based on performing a compensation procedure for the antenna array of the UE based on the misalignment factor.

In some examples, the capability transmitter 640 may be configured as or otherwise support a means for transmitting, to the network entity, an indication of a capability of the UE to perform the alignment procedure for the antenna array of the UE, where the configuration for the alignment procedure is received at least in part in response to the capability.

In some examples, the control signaling receiver 625 may be configured as or otherwise support a means for receiving, from the network entity, a control message indicating for the UE to perform the alignment procedure, where the UE determines the misalignment factor at least in part in response to receiving the control message.

In some examples, the received control message identifies one or more parameters that the UE is to use for the alignment procedure.

In some examples, to support identifying the misalignment factor, the reference signal receiver 645 may be configured as or otherwise support a means for receiving a reference signal from the network entity according to the configuration for the alignment procedure. In some examples, to support identifying the misalignment factor, the misalignment determination component 650 may be configured as or otherwise support a means for determining the misalignment factor for the antenna array based on the received reference signal from the network entity.

In some examples, the reference signal transmitter 655 may be configured as or otherwise support a means for transmitting a second reference signal according to the configuration for the network entity, the transmitted second reference signal for the network entity to perform the alignment procedure on a second antenna array of the network entity.

In some examples, the received reference signal includes a channel state information reference signal.

In some examples, to support identifying the misalignment factor, the reference signal transmitter 655 may be configured as or otherwise support a means for transmitting a reference signal according to the configuration for the alignment procedure. In some examples, to support identifying the misalignment factor, the misalignment factor receiver 660 may be configured as or otherwise support a means for receiving, from the network entity, the misalignment factor for the antenna array at least in part in response to the transmitted reference signal.

In some examples, the control signaling receiver 625 may be configured as or otherwise support a means for receiving a control message identifying a set of misalignment factors, where receiving the misalignment factor includes receiving an indicator of the misalignment factor from the set of misalignment factors.

In some examples, receiving the misalignment factor is associated with an expiry of an alignment timer, or a misalignment value satisfying an alignment threshold, or a combination thereof.

In some examples, the indicator of the misalignment factor from the set of misalignment factors is received in a media access control element or a downlink control information message.

In some examples, to support receiving the misalignment factor, the control signaling receiver 625 may be configured as or otherwise support a means for receiving a downlink control information message identifying the misalignment factor.

In some examples, the transmitted reference signal includes a sounding reference signal.

In some examples, performing the compensation procedure for the antenna array according to the misalignment factor includes modifying a physical parameter of the antenna array, a pre-processing procedure for signals to be transmitted by the UE, a post-processing procedure for signals received by the UE, or any combination thereof.

In some examples, the compensation procedure is performed at least in part by the UE and is performed at least in part by the network entity.

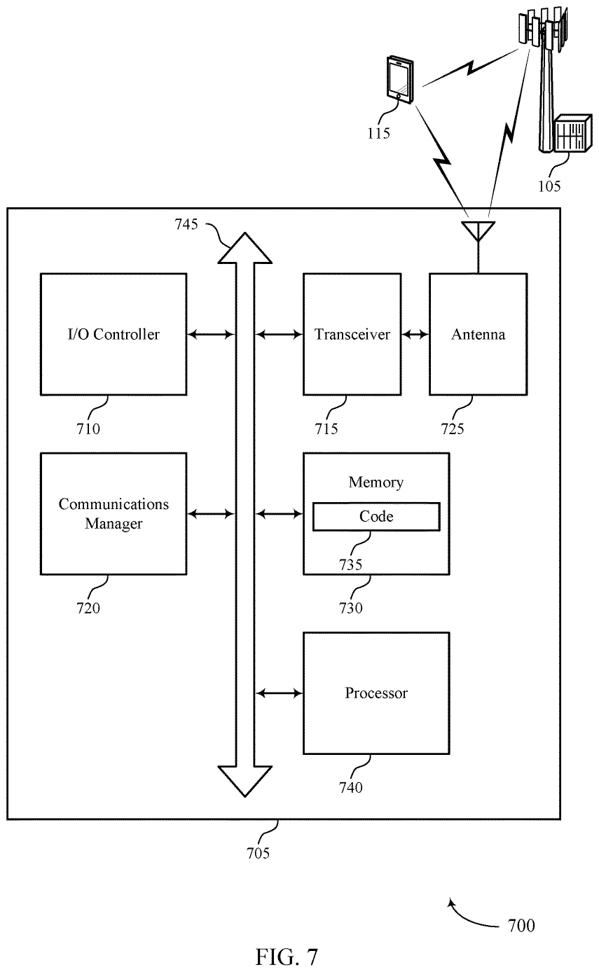

FIG. 7 shows a diagram of a system 700 including a device 705 that supports signaling aspects of misalignment estimation and compensation for LOS MIMO communications in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting signaling aspects of misalignment estimation and compensation for LOS MIMO communications). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving control signaling identifying a configuration for an alignment procedure for an antenna array of the UE that includes a set of multiple antenna elements. The communications manager 720 may be configured as or otherwise support a means for identifying a misalignment factor for the antenna array according to the identified configuration. The communications manager 720 may be configured as or otherwise support a means for communicating with the network entity using the antenna array based on performing a compensation procedure for the antenna array of the UE based on the misalignment factor.

By including or configuring the communications manager 720 in accordance with examples as described herein, the device 705 may support techniques for misalignment estimation to adjust antennas at the UE, a base station, or other communicating devices, resulting in improved communication reliability, reduced latency, more efficient utilization of communication resources, improved coordination between devices, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of signaling aspects of misalignment estimation and compensation for LOS MIMO communications as described herein, or the processor 740 and the memory 730 may be otherwise configured to perform or support such operations.

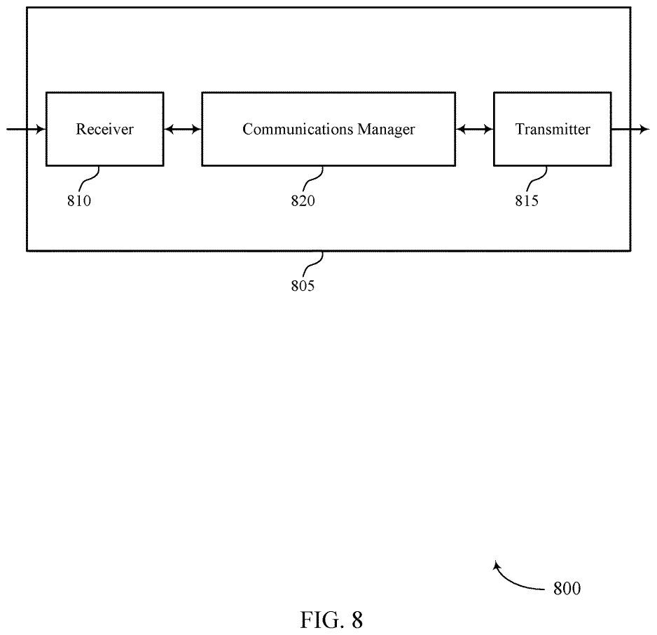

FIG. 8 shows a block diagram 800 of a device 805 that supports signaling aspects of misalignment estimation and compensation for LOS MIMO communications in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to signaling aspects of misalignment estimation and compensation for LOS MIMO communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to signaling aspects of misalignment estimation and compensation for LOS MIMO communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of signaling aspects of misalignment estimation and compensation for LOS MIMO communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a network entity in accordance with examples as disclosed herein. For example, the communications manager 820 may be configured as or otherwise support a means for transmitting, to a UE, control signaling identifying a configuration for an alignment procedure for an antenna array of the network entity that includes a set of multiple antenna elements. The communications manager 820 may be configured as or otherwise support a means for identifying a misalignment factor for the antenna array according to the identified configuration. The communications manager 820 may be configured as or otherwise support a means for communicating with the UE using the antenna array based on performing a compensation procedure for the antenna array of the network entity based on the misalignment factor.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for misalignment estimation to adjust antennas at a UE, the base station, or other communicating devices, resulting in reduced processing, reduced power consumption, more efficient utilization of communication resources, and higher throughput communications.

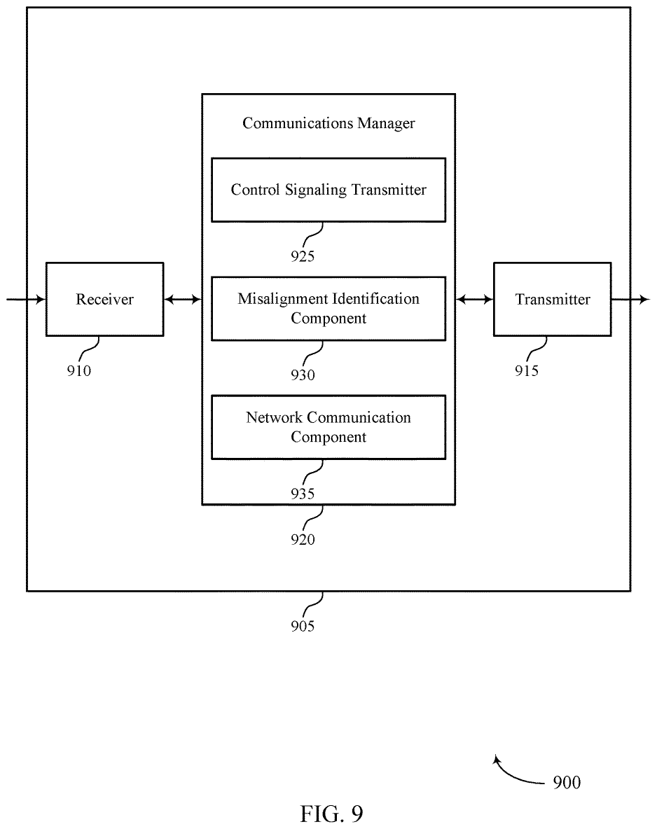

FIG. 9 shows a block diagram 900 of a device 905 that supports signaling aspects of misalignment estimation and compensation for LOS MIMO communications in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to signaling aspects of misalignment estimation and compensation for LOS MIMO communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to signaling aspects of misalignment estimation and compensation for LOS MIMO communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of signaling aspects of misalignment estimation and compensation for LOS MIMO communications as described herein. For example, the communications manager 920 may include a control signaling transmitter 925, a misalignment identification component 930, a network communication component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network entity in accordance with examples as disclosed herein. The control signaling transmitter 925 may be configured as or otherwise support a means for transmitting, to a UE, control signaling identifying a configuration for an alignment procedure for an antenna array of the network entity that includes a set of multiple antenna elements. The misalignment identification component 930 may be configured as or otherwise support a means for identifying a misalignment factor for the antenna array according to the identified configuration. The network communication component 935 may be configured as or otherwise support a means for communicating with the UE using the antenna array based on performing a compensation procedure for the antenna array of the network entity based on the misalignment factor.

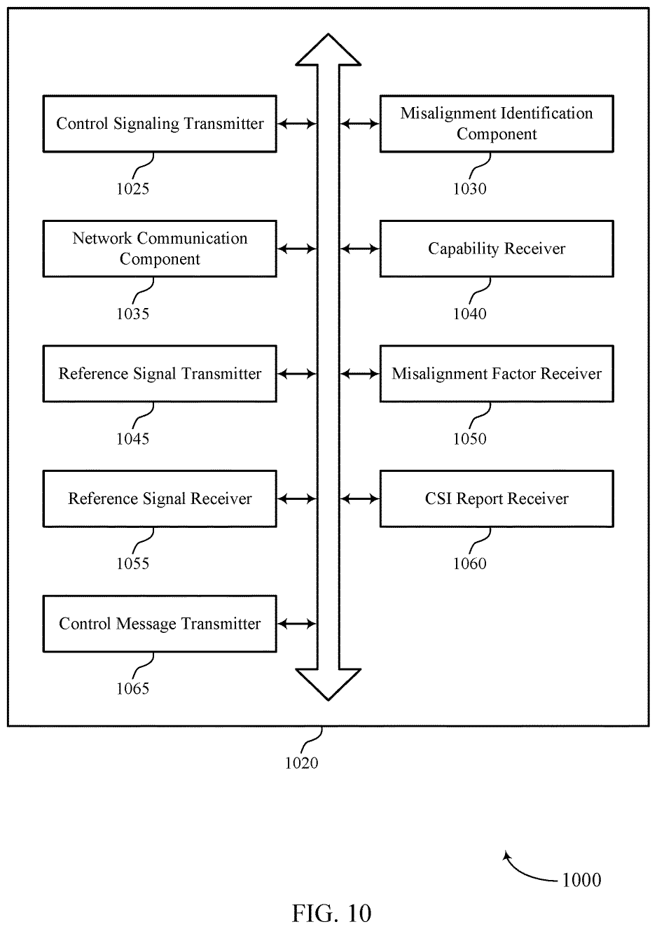

FIG. 10 shows a block diagram 1000 of a communications manager 1020 that supports signaling aspects of misalignment estimation and compensation for LOS MIMO communications in accordance with aspects of the present disclosure. The communications manager 1020 may be an example of aspects of a communications manager 820, a communications manager 920, or both, as described herein. The communications manager 1020, or various components thereof, may be an example of means for performing various aspects of signaling aspects of misalignment estimation and compensation for LOS MIMO communications as described herein. For example, the communications manager 1020 may include a control signaling transmitter 1025, a misalignment identification component 1030, a network communication component 1035, a capability receiver 1040, a reference signal transmitter 1045, a misalignment factor receiver 1050, a reference signal receiver 1055, a CSI report receiver 1060, a control message transmitter 1065, or any combination thereof. Each of these components may communicate, directly or indirectly, with one another (e.g., via one or more buses).

The communications manager 1020 may support wireless communication at a network entity in accordance with examples as disclosed herein. The control signaling transmitter 1025 may be configured as or otherwise support a means for transmitting, to a UE, control signaling identifying a configuration for an alignment procedure for an antenna array of the network entity that includes a set of multiple antenna elements. The misalignment identification component 1030 may be configured as or otherwise support a means for identifying a misalignment factor for the antenna array according to the identified configuration. The network communication component 1035 may be configured as or otherwise support a means for communicating with the UE using the antenna array based on performing a compensation procedure for the antenna array of the network entity based on the misalignment factor.

In some examples, the capability receiver 1040 may be configured as or otherwise support a means for receiving, from the UE, an indication of a capability of the UE to perform the alignment procedure, where the configuration for the alignment procedure is transmitted at least in part in response to the capability.

In some examples, the control signaling transmitter 1025 may be configured as or otherwise support a means for transmitting, to the UE, a control message indicating for the UE to perform the alignment procedure.

In some examples, to support identifying the misalignment factor, the reference signal transmitter 1045 may be configured as or otherwise support a means for transmitting a reference signal to the UE according to the configuration for the alignment procedure. In some examples, to support identifying the misalignment factor, the misalignment factor receiver 1050 may be configured as or otherwise support a means for receiving, from the UE, the misalignment factor for the antenna array at least in part in response to the transmitted reference signal.

In some examples, to support receiving the misalignment factor for the antenna array at least in part in response to the transmitted reference signal, the CSI report receiver 1060 may be configured as or otherwise support a means for receiving a channel state information report including one or more of a channel quality information field, precoding matrix indicator, rank indicator, or any combination thereof, that indicate the misalignment factor.

In some examples, the control message transmitter 1065 may be configured as or otherwise support a means for transmitting a control message identifying a set of misalignment factors, where receiving the misalignment factor includes receiving an indicator of the misalignment factor from the set of misalignment factors.

In some examples, transmitting the misalignment factor is associated with an expiry of an alignment timer, or a misalignment value satisfying an alignment threshold, or a combination thereof.

In some examples, the indicator of the misalignment factor from the set of misalignment factors is transmitted in a media access control element or a downlink control information message.

In some examples, to support identifying the misalignment factor, the reference signal receiver 1055 may be configured as or otherwise support a means for receiving a reference signal from the UE entity according to the configuration for the alignment procedure. In some examples, to support identifying the misalignment factor, the misalignment identification component 1030 may be configured as or otherwise support a means for determining the misalignment factor for the antenna array based on the received reference signal from the UE.

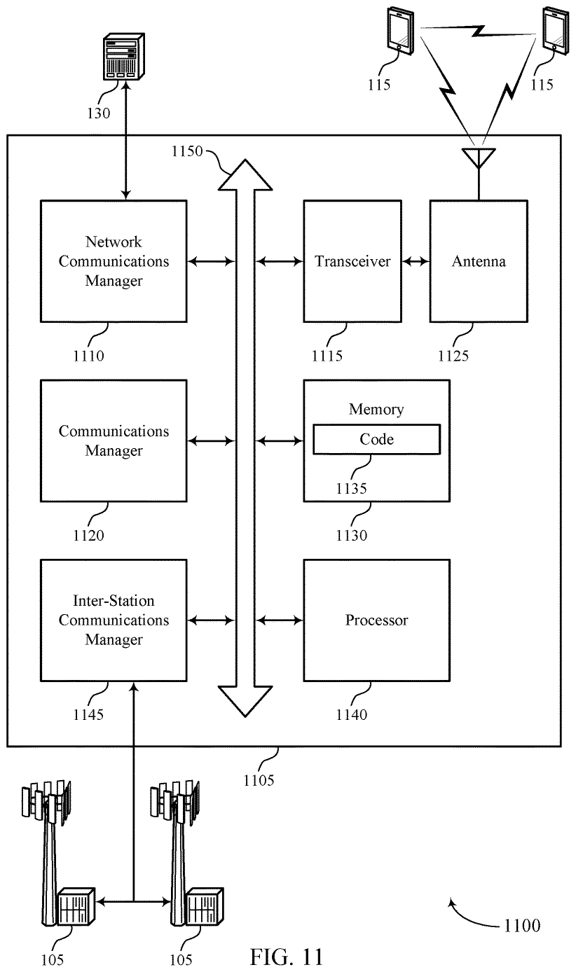

FIG. 11 shows a diagram of a system 1100 including a device 1105 that supports signaling aspects of misalignment estimation and compensation for LOS MIMO communications in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting signaling aspects of misalignment estimation and compensation for LOS MIMO communications). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a network entity in accordance with examples as disclosed herein. For example, the communications manager 1120 may be configured as or otherwise support a means for transmitting, to a UE, control signaling identifying a configuration for an alignment procedure for an antenna array of the network entity that includes a set of multiple antenna elements. The communications manager 1120 may be configured as or otherwise support a means for identifying a misalignment factor for the antenna array according to the identified configuration. The communications manager 1120 may be configured as or otherwise support a means for communicating with the UE using the antenna array based on performing a compensation procedure for the antenna array of the network entity based on the misalignment factor.

By including or configuring the communications manager 1120 in accordance with examples as described herein, the device 1105 may support techniques for misalignment estimation to adjust antennas at the UE, a base station, or other communicating devices, resulting in improved communication reliability, reduced power consumption, more efficient utilization of communication resources, improved coordination between devices, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of signaling aspects of misalignment estimation and compensation for LOS MIMO communications as described herein, or the processor 1140 and the memory 1130 may be otherwise configured to perform or support such operations.

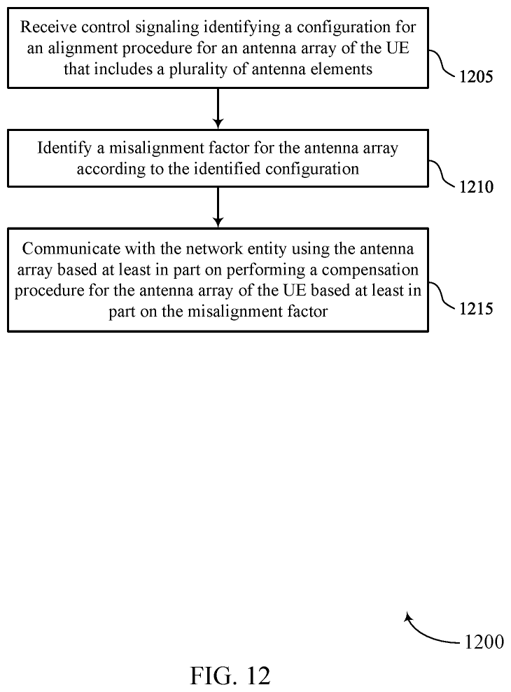

FIG. 12 shows a flowchart illustrating a method 1200 that supports signaling aspects of misalignment estimation and compensation for LOS MIMO communications in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving control signaling identifying a configuration for an alignment procedure for an antenna array of the UE that includes a set of multiple antenna elements. The operations of 1205 may be performed in accordance with examples as disclosed herein. In some examples, aspects of the operations of 1205 may be performed by a control signaling receiver 625 as described with reference to FIG. 6.

At 1210, the method may include identifying a misalignment factor for the antenna array according to the identified configuration. The operations of 1210 may be performed in accordance with examples as disclosed herein. In some examples, aspects of the operations of 1210 may be performed by a misalignment identification component 630 as described with reference to FIG. 6.

At 1215, the method may include communicating with the network entity using the antenna array based on performing a compensation procedure for the antenna array of the UE based on the misalignment factor. The operations of 1215 may be performed in accordance with examples as disclosed herein. In some examples, aspects of the operations of 1215 may be performed by a network communication component 635 as described with reference to FIG. 6.

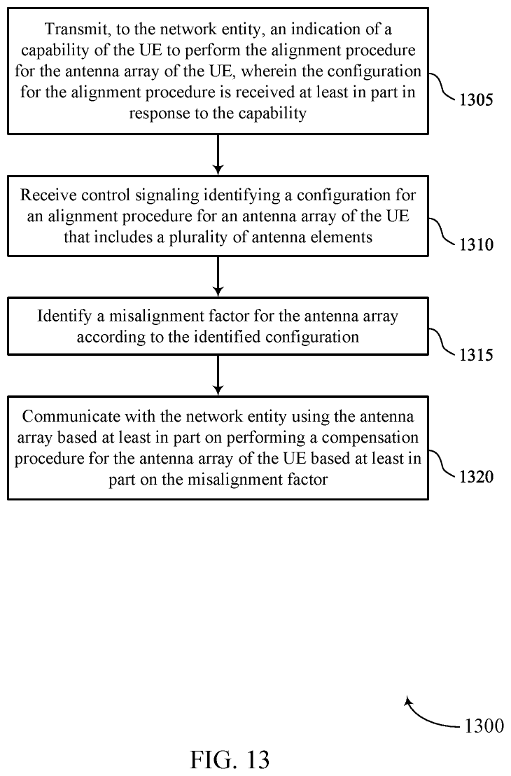

FIG. 13 shows a flowchart illustrating a method 1300 that supports signaling aspects of misalignment estimation and compensation for LOS MIMO communications in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include transmitting, to the network entity, an indication of a capability of the UE to perform the alignment procedure for the antenna array of the UE, where the configuration for the alignment procedure is received at least in part in response to the capability. The operations of 1305 may be performed in accordance with examples as disclosed herein. In some examples, aspects of the operations of 1305 may be performed by a capability transmitter 640 as described with reference to FIG. 6.

At 1310, the method may include receiving control signaling identifying a configuration for an alignment procedure for an antenna array of the UE that includes a set of multiple antenna elements. The operations of 1310 may be performed in accordance with examples as disclosed herein. In some examples, aspects of the operations of 1310 may be performed by a control signaling receiver 625 as described with reference to FIG. 6.

At 1315, the method may include identifying a misalignment factor for the antenna array according to the identified configuration. The operations of 1315 may be performed in accordance with examples as disclosed herein. In some examples, aspects of the operations of 1315 may be performed by a misalignment identification component 630 as described with reference to FIG. 6.

At 1320, the method may include communicating with the network entity using the antenna array based on performing a compensation procedure for the antenna array of the UE based on the misalignment factor. The operations of 1320 may be performed in accordance with examples as disclosed herein. In some examples, aspects of the operations of 1320 may be performed by a network communication component 635 as described with reference to FIG. 6.

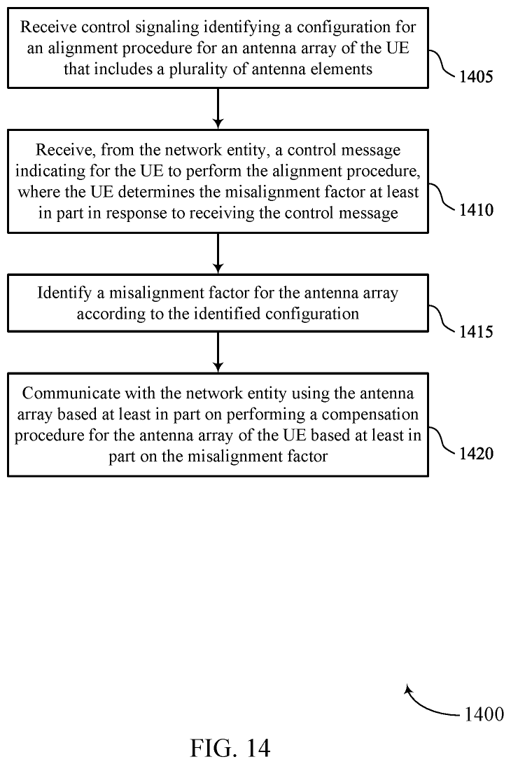

FIG. 14 shows a flowchart illustrating a method 1400 that supports signaling aspects of misalignment estimation and compensation for LOS MIMO communications in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving control signaling identifying a configuration for an alignment procedure for an antenna array of the UE that includes a set of multiple antenna elements. The operations of 1405 may be performed in accordance with examples as disclosed herein. In some examples, aspects of the operations of 1405 may be performed by a control signaling receiver 625 as described with reference to FIG. 6.

At 1410, the method may include receiving, from the network entity, a control message indicating for the UE to perform the alignment procedure, where the UE determines the misalignment factor at least in part in response to receiving the control message. The operations of 1410 may be performed in accordance with examples as disclosed herein. In some examples, aspects of the operations of 1410 may be performed by a control signaling receiver 625 as described with reference to FIG. 6.

At 1415, the method may include identifying a misalignment factor for the antenna array according to the identified configuration. The operations of 1415 may be performed in accordance with examples as disclosed herein. In some examples, aspects of the operations of 1415 may be performed by a misalignment identification component 630 as described with reference to FIG. 6.

At 1420, the method may include communicating with the network entity using the antenna array based on performing a compensation procedure for the antenna array of the UE based on the misalignment factor. The operations of 1420 may be performed in accordance with examples as disclosed herein. In some examples, aspects of the operations of 1420 may be performed by a network communication component 635 as described with reference to FIG. 6.

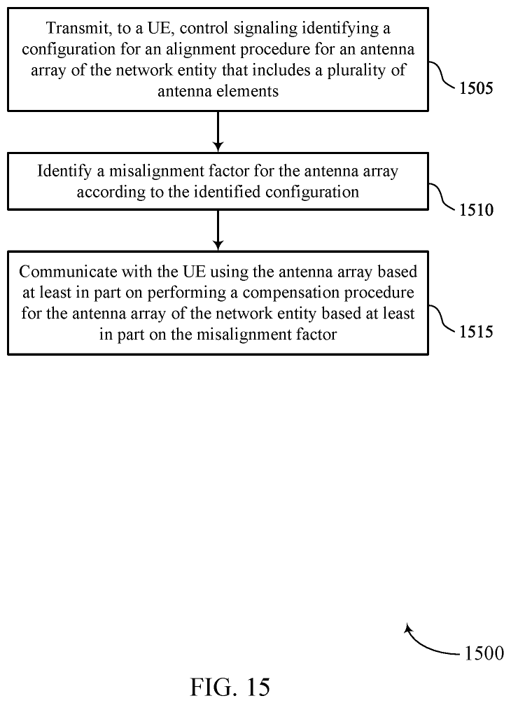

FIG. 15 shows a flowchart illustrating a method 1500 that supports signaling aspects of misalignment estimation and compensation for LOS MIMO communications in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, control signaling identifying a configuration for an alignment procedure for an antenna array of the network entity that includes a set of multiple antenna elements. The operations of 1505 may be performed in accordance with examples as disclosed herein. In some examples, aspects of the operations of 1505 may be performed by a control signaling transmitter 1025 as described with reference to FIG. 10.

At 1510, the method may include identifying a misalignment factor for the antenna array according to the identified configuration. The operations of 1510 may be performed in accordance with examples as disclosed herein. In some examples, aspects of the operations of 1510 may be performed by a misalignment identification component 1030 as described with reference to FIG. 10.

At 1515, the method may include communicating with the UE using the antenna array based on performing a compensation procedure for the antenna array of the network entity based on the misalignment factor. The operations of 1515 may be performed in accordance with examples as disclosed herein. In some examples, aspects of the operations of 1515 may be performed by a network communication component 1035 as described with reference to FIG. 10.

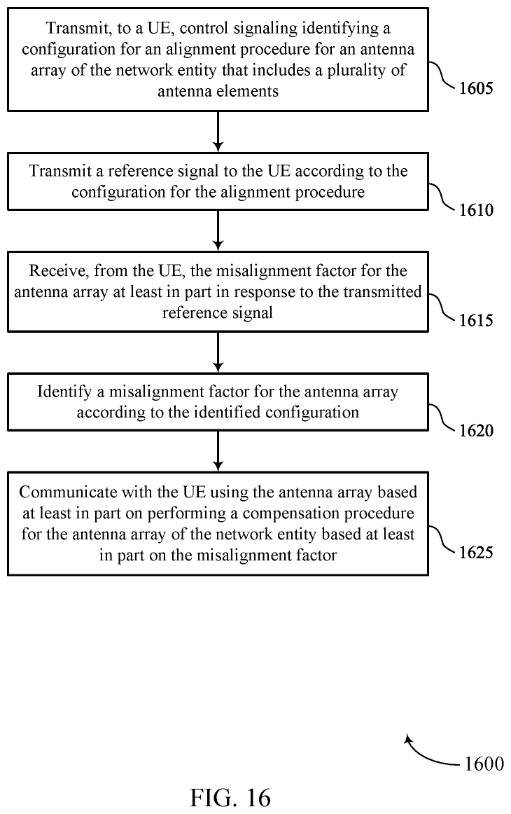

FIG. 16 shows a flowchart illustrating a method 1600 that supports signaling aspects of misalignment estimation and compensation for LOS MIMO communications in accordance with aspects of the present disclosure. The operations of the method 1600 may be implemented by a base station or its components as described herein. For example, the operations of the method 1600 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, control signaling identifying a configuration for an alignment procedure for an antenna array of the network entity that includes a set of multiple antenna elements. The operations of 1605 may be performed in accordance with examples as disclosed herein. In some examples, aspects of the operations of 1605 may be performed by a control signaling transmitter 1025 as described with reference to FIG. 10.

At 1610, the method may include transmitting a reference signal to the UE according to the configuration for the alignment procedure. The operations of 1610 may be performed in accordance with examples as disclosed herein. In some examples, aspects of the operations of 1610 may be performed by a reference signal transmitter 1045 as described with reference to FIG. 10.

At 1615, the method may include receiving, from the UE, the misalignment factor for the antenna array at least in part in response to the transmitted reference signal. The operations of 1615 may be performed in accordance with examples as disclosed herein. In some examples, aspects of the operations of 1615 may be performed by a misalignment factor receiver 1050 as described with reference to FIG. 10.

At 1620, the method may include identifying a misalignment factor for the antenna array according to the identified configuration. The operations of 1620 may be performed in accordance with examples as disclosed herein. In some examples, aspects of the operations of 1620 may be performed by a misalignment identification component 1030 as described with reference to FIG. 10.

At 1625, the method may include communicating with the UE using the antenna array based on performing a compensation procedure for the antenna array of the network entity based on the misalignment factor. The operations of 1625 may be performed in accordance with examples as disclosed herein. In some examples, aspects of the operations of 1625 may be performed by a network communication component 1035 as described with reference to FIG. 10.

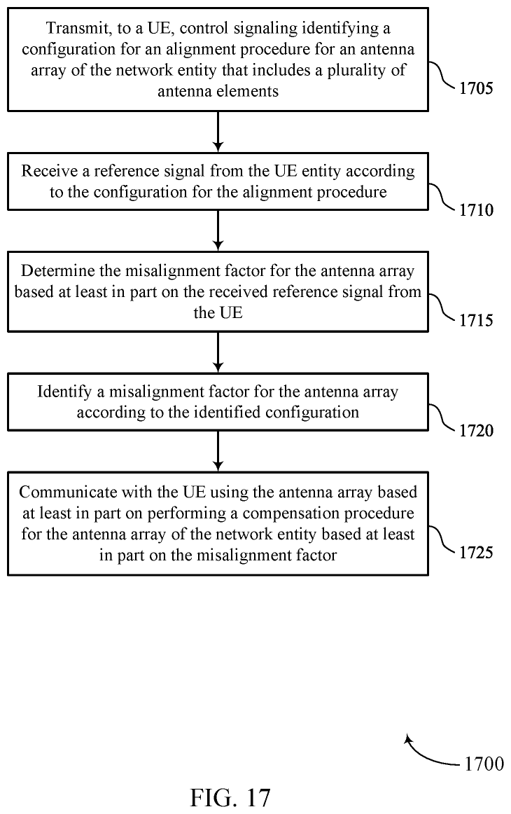

FIG. 17 shows a flowchart illustrating a method 1700 that supports signaling aspects of misalignment estimation and compensation for LOS MIMO communications in accordance with aspects of the present disclosure. The operations of the method 1700 may be implemented by a base station or its components as described herein. For example, the operations of the method 1700 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, control signaling identifying a configuration for an alignment procedure for an antenna array of the network entity that includes a set of multiple antenna elements. The operations of 1705 may be performed in accordance with examples as disclosed herein. In some examples, aspects of the operations of 1705 may be performed by a control signaling transmitter 1025 as described with reference to FIG. 10.

At 1710, the method may include receiving a reference signal from the UE entity according to the configuration for the alignment procedure. The operations of 1710 may be performed in accordance with examples as disclosed herein. In some examples, aspects of the operations of 1710 may be performed by a reference signal receiver 1055 as described with reference to FIG. 10.

At 1715, the method may include determining the misalignment factor for the antenna array based on the received reference signal from the UE. The operations of 1715 may be performed in accordance with examples as disclosed herein. In some examples, aspects of the operations of 1715 may be performed by a misalignment identification component 1030 as described with reference to FIG. 10.

At 1720, the method may include identifying a misalignment factor for the antenna array according to the identified configuration. The operations of 1720 may be performed in accordance with examples as disclosed herein. In some examples, aspects of the operations of 1720 may be performed by a misalignment identification component 1030 as described with reference to FIG. 10.

At 1725, the method may include communicating with the UE using the antenna array based on performing a compensation procedure for the antenna array of the network entity based on the misalignment factor. The operations of 1725 may be performed in accordance with examples as disclosed herein. In some examples, aspects of the operations of 1725 may be performed by a network communication component 1035 as described with reference to FIG. 10.

The following provides an overview of aspects of the present disclosure:
Aspect 1: A method for wireless communication at a UE, comprising: receiving control signaling identifying a configuration for an alignment procedure for an antenna array of the UE that includes a plurality of antenna elements: identifying a misalignment factor for the antenna array according to the identified configuration; and communicating with the network entity using the antenna array based at least in part on performing a compensation procedure for the antenna array of the UE based at least in part on the misalignment factor.
Aspect 2: The method of aspect 1, further comprising: transmitting, to the network entity, an indication of a capability of the UE to perform the alignment procedure for the antenna array of the UE, wherein the configuration for the alignment procedure is received at least in part in response to the capability.
Aspect 3: The method of any of aspects 1 through 2, further comprising: receiving, from the network entity, a control message indicating for the UE to perform the alignment procedure, where the UE determines the misalignment factor at least in part in response to receiving the control message.
Aspect 4: The method of aspect 3, wherein the received control message identifies one or more parameters that the UE is to use for the alignment procedure.
Aspect 5: The method of any of aspects 1 through 4, wherein identifying the misalignment factor comprises: receiving a reference signal from the network entity according to the configuration for the alignment procedure; and determining the misalignment factor for the antenna array based at least in part on the received reference signal from the network entity.
Aspect 6: The method of aspect 5, further comprising: transmitting a second reference signal according to the configuration for the network entity, the transmitted second reference signal for the network entity to perform the alignment procedure on a second antenna array of the network entity.
Aspect 7: The method of any of aspects 5 through 6, wherein the received reference signal comprises a channel state information reference signal.
Aspect 8: The method of any of aspects 1 through 7, wherein identifying the misalignment factor comprises: transmitting a reference signal according to the configuration for the alignment procedure; and receiving, from the network entity, the misalignment factor for the antenna array at least in part in response to the transmitted reference signal.
Aspect 9: The method of aspect 8, further comprising: receiving a control message identifying a set of misalignment factors, wherein receiving the misalignment factor comprises receiving an indicator of the misalignment factor from the set of misalignment factors.
Aspect 10: The method of aspect 9, wherein receiving the misalignment factor is associated with an expiry of an alignment timer, or a misalignment value satisfying an alignment threshold, or a combination thereof.
Aspect 11: The method of any of aspects 9 through 10, wherein the indicator of the misalignment factor from the set of misalignment factors is received in a media access control element or a downlink control information message.
Aspect 12: The method of any of aspects 8 through 11, wherein receiving the misalignment factor comprises: receiving a downlink control information message identifying the misalignment factor.
Aspect 13: The method of any of aspects 8 through 12, wherein the transmitted reference signal comprises a sounding reference signal.
Aspect 14: The method of any of aspects 1 through 13, wherein performing the compensation procedure for the antenna array according to the misalignment factor comprises modifying a physical parameter of the antenna array, a pre-processing procedure for signals to be transmitted by the UE, a post-processing procedure for signals received by the UE, or any combination thereof.
Aspect 15: The method of any of aspects 1 through 14, wherein the compensation procedure is performed at least in part by the UE and is performed at least in part by the network entity.
Aspect 16: A method for wireless communication at a network entity, comprising: transmitting, to a UE, control signaling identifying a configuration for an alignment procedure for an antenna array of the network entity that includes a plurality of antenna elements: identifying a misalignment factor for the antenna array according to the identified configuration; and communicating with the UE using the antenna array based at least in part on performing a compensation procedure for the antenna array of the network entity based at least in part on the misalignment factor.
Aspect 17: The method of aspect 16, further comprising: receiving, from the UE, an indication of a capability of the UE to perform the alignment procedure, wherein the configuration for the alignment procedure is transmitted at least in part in response to the capability.
Aspect 18: The method of any of aspects 16 through 17, further comprising: transmitting, to the UE, a control message indicating for the UE to perform the alignment procedure.
Aspect 19: The method of any of aspects 16 through 18, wherein identifying the misalignment factor comprises: transmitting a reference signal to the UE according to the configuration for the alignment procedure; and receiving, from the UE, the misalignment factor for the antenna array at least in part in response to the transmitted reference signal.
Aspect 20: The method of aspect 19, wherein receiving the misalignment factor for the antenna array at least in part in response to the transmitted reference signal comprises: receiving a channel state information report comprising one or more of a channel quality information field, precoding matrix indicator, rank indicator, or any combination thereof, that indicate the misalignment factor.
Aspect 21: The method of any of aspects 19 through 20, further comprising: transmitting a control message identifying a set of misalignment factors, wherein receiving the misalignment factor comprises receiving an indicator of the misalignment factor from the set of misalignment factors.
Aspect 22: The method of aspect 21, wherein transmitting the misalignment factor is associated with an expiry of an alignment timer, or a misalignment value satisfying an alignment threshold, or a combination thereof.
Aspect 23: The method of any of aspects 21 through 22, wherein the indicator of the misalignment factor from the set of misalignment factors is transmitted in a media access control element or a downlink control information message.
Aspect 24: The method of any of aspects 16 through 23, wherein identifying the misalignment factor comprises: receiving a reference signal from the UE entity according to the configuration for the alignment procedure; and determining the misalignment factor for the antenna array based at least in part on the received reference signal from the UE.
Aspect 25: An apparatus for wireless communication at a UE, comprising a processor: memory coupled with the processor; and instructions stored in the memory and executable by the processor to cause the apparatus to perform a method of any of aspects 1 through 15.
Aspect 26: An apparatus for wireless communication at a UE, comprising at least one means for performing a method of any of aspects 1 through 15.
Aspect 27: A non-transitory computer-readable medium storing code for wireless communication at a UE, the code comprising instructions executable by a processor to perform a method of any of aspects 1 through 15.
Aspect 28: An apparatus for wireless communication at a network entity, comprising a processor; memory coupled with the processor; and instructions stored in the memory and executable by the processor to cause the apparatus to perform a method of any of aspects 16 through 24.
Aspect 29: An apparatus for wireless communication at a network entity, comprising at least one means for performing a method of any of aspects 16 through 24.
Aspect 30: A non-transitory computer-readable medium storing code for wireless communication at a network entity, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, control signaling identifying a configuration for an alignment procedure for an antenna array of the UE that includes a plurality of antenna elements;
identifying a misalignment factor for the antenna array according to the identified configuration; and
communicating with the network entity using the antenna array based at least in part on performing a compensation procedure for the antenna array of the UE based at least in part on the misalignment factor.

2. The method of claim 1, further comprising:
transmitting, to the network entity, an indication of a capability of the UE to perform the alignment procedure for the antenna array of the UE, wherein the configuration for the alignment procedure is received at least in part in response to the capability.

3. The method of claim 1, further comprising:
receiving, from the network entity, a control message indicating for the UE to perform the alignment procedure, where the UE determines the misalignment factor at least in part in response to receiving the control message.

4. The method of claim 3, wherein the received control message identifies one or more parameters that the UE is to use for the alignment procedure.

5. The method of claim 1, wherein identifying the misalignment factor comprises:
receiving a reference signal from the network entity according to the configuration for the alignment procedure; and
determining the misalignment factor for the antenna array based at least in part on the received reference signal from the network entity.

6. The method of claim 5, further comprising:
transmitting a second reference signal according to the configuration for the network entity, the transmitted second reference signal for the network entity to perform the alignment procedure on a second antenna array of the network entity.

7. The method of claim 5, wherein the received reference signal comprises a channel state information reference signal.

8. The method of claim 1, wherein identifying the misalignment factor comprises:
transmitting a reference signal according to the configuration for the alignment procedure; and
receiving, from the network entity, the misalignment factor for the antenna array at least in part in response to the transmitted reference signal.

9. The method of claim 8, further comprising:
receiving a control message identifying a set of misalignment factors, wherein receiving the misalignment factor comprises receiving an indicator of the misalignment factor from the set of misalignment factors.

10. The method of claim 9, wherein receiving the misalignment factor is associated with an expiry of an alignment timer, or a misalignment value satisfying an alignment threshold, or a combination thereof.

11. The method of claim 9, wherein the indicator of the misalignment factor from the set of misalignment factors is received in a media access control element or a downlink control information message.

12. The method of claim 8, wherein receiving the misalignment factor comprises:
receiving a downlink control information message identifying the misalignment factor.

13. The method of claim 8, wherein the transmitted reference signal comprises a sounding reference signal.

14. The method of claim 1, wherein performing the compensation procedure for the antenna array according to the misalignment factor comprises modifying a physical parameter of the antenna array, a pre-processing procedure for signals to be transmitted by the UE, a post-processing procedure for signals received by the UE, or any combination thereof.

15. The method of claim 1, wherein the compensation procedure is performed at least in part by the UE and is performed at least in part by the network entity.

16. A method for wireless communication at a network entity, comprising:
transmitting, to a user equipment (UE), control signaling identifying a configuration for an alignment procedure for an antenna array of the network entity that includes a plurality of antenna elements;
identifying a misalignment factor for the antenna array according to the identified configuration; and
communicating with the UE using the antenna array based at least in part on performing a compensation procedure for the antenna array of the network entity based at least in part on the misalignment factor.

17. The method of claim 16, further comprising:
receiving, from the UE, an indication of a capability of the UE to perform the alignment procedure, wherein the configuration for the alignment procedure is transmitted at least in part in response to the capability.

18. The method of claim 16, further comprising:
transmitting, to the UE, a control message indicating for the UE to perform the alignment procedure.

19. The method of claim 16, wherein identifying the misalignment factor comprises:
transmitting a reference signal to the UE according to the configuration for the alignment procedure; and
receiving, from the UE, the misalignment factor for the antenna array at least in part in response to the transmitted reference signal.

20. The method of claim 19, wherein receiving the misalignment factor for the antenna array at least in part in response to the transmitted reference signal comprises:
receiving a channel state information report comprising one or more of a channel quality information field, precoding matrix indicator, rank indicator, or any combination thereof, that indicate the misalignment factor.

21. The method of claim 19, further comprising:
transmitting a control message identifying a set of misalignment factors, wherein receiving the misalignment factor comprises receiving an indicator of the misalignment factor from the set of misalignment factors.

22. The method of claim 21, wherein transmitting the misalignment factor is associated with an expiry of an alignment timer, or a misalignment value satisfying an alignment threshold, or a combination thereof.

23. The method of claim 21, wherein the indicator of the misalignment factor from the set of misalignment factors is transmitted in a media access control element or a downlink control information message.

24. The method of claim 16, wherein identifying the misalignment factor comprises:
receiving a reference signal from the UE entity according to the configuration for the alignment procedure; and
determining the misalignment factor for the antenna array based at least in part on the received reference signal from the UE.

25. An apparatus for wireless communication at a user equipment (UE), comprising:
a processor;
memory coupled with the processor; and
instructions stored in the memory and executable by the processor to cause the apparatus to:
receive, from a network entity, control signaling identifying a configuration for an alignment procedure for an antenna array of the UE that includes a plurality of antenna elements;
identify a misalignment factor for the antenna array according to the identified configuration; and
communicate with the network entity using the antenna array based at least in part on performing a compensation procedure for the antenna array of the UE based at least in part on the misalignment factor.

26. The apparatus of claim 25, wherein the instructions are further executable by the processor to cause the apparatus to:
transmit, to the network entity, an indication of a capability of the UE to perform the alignment procedure for the antenna array of the UE, wherein the configuration for the alignment procedure is received at least in part in response to the capability.

27. The apparatus of claim 25, wherein the instructions are further executable by the processor to cause the apparatus to:
receive, from the network entity, a control message indicating for the UE to perform the alignment procedure, where the UE determines the misalignment factor at least in part in response to receiving the control message.

28. The apparatus of claim 27, wherein the received control message identifies one or more parameters that the UE is to use for the alignment procedure.

29. An apparatus for wireless communication at a network entity, comprising:
a processor;
memory coupled with the processor; and
instructions stored in the memory and executable by the processor to cause the apparatus to:
transmit, to a user equipment (UE), control signaling identifying a configuration for an alignment procedure for an antenna array of the network entity that includes a plurality of antenna elements;
identify a misalignment factor for the antenna array according to the identified configuration; and
communicate with the UE using the antenna array based at least in part on performing a compensation procedure for the antenna array of the network entity based at least in part on the misalignment factor.

30. The apparatus of claim 29, wherein the instructions are further executable by the processor to cause the apparatus to:
receive, from the UE, an indication of a capability of the UE to perform the alignment procedure, wherein the configuration for the alignment procedure is transmitted at least in part in response to the capability.
